(19) United States
(12) Patent Application Publication
(10) Pub. No.: US 2005/0193820 A1
(43) Pub. Date: Sep. 8, 2005

(54) Integrated sensor and motion sensing for ultrasound and other devices

(75) Inventors: Todor Sheljaskow, Issaquah, WA (US); Vaughn R. Marian, Saratoga, CA (US); Nelson H. Oliver, Sunnyvale, CA (US)

Correspondence Address: Siemens Corporation;Intellectual Property Department, 170 Wood Avenue South, Iselin, NJ, 08830, US

(73) Assignee: Siemens Medical Solutions USA, Inc.

(21) Appl. No.: 10/792,939

(22) Filed: Mar. 4, 2004

(51) Int. Cl. G01N 29/00

(52) U.S. Cl. 73/649

(57) ABSTRACT

Detecting damage risk or preventing damage in handheld electronics devices uses an integrated motion sensor. To detect damage risk, a shock sensor is positioned in a handheld electronics device, such as on or within a housing of the electronics device. Through a display, communication or other mechanism, shock information is provided to assess a type or amount of damage to a product. For preventing damage in a handheld electronics device, a drop is detected within the handheld electronics device. In response to the detected drop, a component within the handheld electronics device is positioned. For example, the component is moved from a position of risk during a shock to a position of lesser risk during a shock. The handheld electronics device is free of mechanical connection to other devices, such as a cell phone, a personal digital assistant, a CD player, a tape player, a radio or other device of handheld size that is carryable or worn by a person. In other embodiments, the handheld electronics device connects through a cable or other mechanical connection to other devices, such as a transducer probe used in medical diagnostic ultrasound imaging.

### BACKGROUND

The present invention relates to handheld devices. In particular, devices for assessing or preventing damage are integrated in a handheld electronics device.

Active electronics devices may be harmed by shock. For example, a user of a cell phone or personal data assistant drops the handheld electronics onto a concrete or other hard surface. Damage caused may be visible, such as harming an LCD or other display, or may not be visible. Likewise, mechanical devices on a handheld electronics device may be injured due to shock, such as breaking an antenna on a cell phone. Broken or malfunctioning handheld electronics may be returned for repair. To assess payment under warranty, the type of damage, such as by the user rather than a defect in manufacture, may be important. However, determining the cause of damage may be difficult in some situations. Knowing the typical extent of shock or other source of damage may allow for product improvements to better protect handheld electronics.

Detecting a possibility of damage may also allow avoidance of damage. For example, laptop computers have an accelerometer to detect a drop of laptop computer. In response to the detected drop and prior to any shock, the read/write head of a hard disc drive is locked into a safe position.

Shock sensors are used to assess shipping damage. A shock sensor is positioned on packaging or in a shipping container with products. Upon receipt of the container or products and packaging, the shock sensor is used to verify whether the products were exposed to excessive shock.

### BRIEF SUMMARY

By way of introduction, the preferred embodiments described below include methods and systems for detecting damage risk or preventing damage in handheld electronics devices. To detect damage risk, a shock sensor is positioned in a handheld electronics device, such as on or within a housing of the electronics device. Through a display, communication or other mechanism, shock information is provided to assess a type or amount of damage to a product.

For preventing damage in a handheld electronics device, a drop is detected within the handheld electronics device. In response to the detected drop, a component within the handheld electronics device is positioned. For example, the component is moved from a position of risk during a shock to a position of lesser risk during a shock.

In one embodiment, the handheld electronics device is free of mechanical connection to other devices, such as a cell phone, a personal digital assistant, a CD player, a tape player, a radio or other device of handheld size that is carryable or worn by a person. In other embodiments, the handheld electronics device connects through a cable or other mechanical connection to other devices, such as a transducer probe used in medical diagnostic ultrasound imaging.

In one aspect, an ultrasound transducer probe for detecting damage risk or preventing damage is provided. A probe housing at least partially houses a transducer array. A motion sensor is operable to detect one of a shock and a drop of the probe housing. The motion sensor is in the probe housing.

In a second aspect, a system for detecting damage risk or preventing damage in a handheld electronics device is provided. A housing at least partially encloses the handheld electronics device. A motion sensor is in the housing. The motion sensor is operable to detect one of a shock and a drop of the handheld electronics device.

In a third aspect, a method for detecting damage risk in a handheld electronics device is provided. Shock is detected from within the handheld electronics device. The detected shock is then indicated.

In a fourth aspect, a method for preventing damage in a handheld electronics device is provided. A drop is detected from within the handheld electronics device. A component is positioned in response to the detected drop.

The present invention is defined by the following claims, and nothing in this section should be taken as a limitation on those claims. Further aspects and advantages of the invention are discussed below in conjunction with the preferred embodiments. The aspects above or other disclosure herein may be used independently and later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a handheld electronics system;

FIG. 2 is a cutaway graphical representation of one embodiment of an ultrasound transducer with a motion sensor;

FIG. 3 is a cutaway view of another embodiment of an ultrasound transducer with a motion sensor;

FIG. 4 is a flowchart diagram of one embodiment of a method for detecting damage risk; and

FIG. 5 is a flowchart diagram of one embodiment of a method for preventing damage in a handheld electronics device.

### DETAILED DESCRIPTION OF THE DRAWINGS AND PRESENTLY

### PREFERRED EMBODIMENTS

Handheld electronics devices, such as transducer probes with active electronics, may be susceptible to damage from sudden shocks. To detect shock damage that has previously occurred for verifying warranty information or for adapting designs to avoid damage, a motion sensor is provided in the handheld electronics device. For preventing damage, a motion sensor in the handheld electronics device detects that the device has been dropped. In response to the detected drop, a device is positioned to minimize damage before the impact. For example, a transducer within a wobbler transducer probe is positioned to a side location rather than a more damage prone center location.

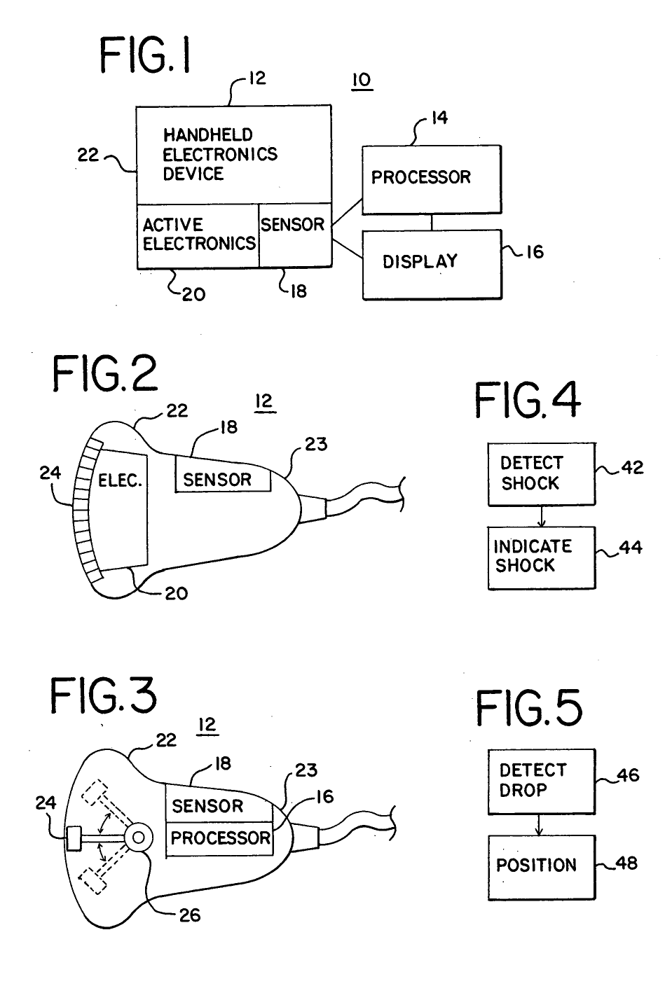

FIG. 1 shows a system 10 for detecting damage risk or preventing damage in a handheld electronics device 12. The system 10 includes the handheld electronics device 12, an optional processor 14, and an optional display 16. Additional, different or fewer components may be provided. For example, the handheld electronics device 12 is provided without the processor 14 or display 16. As another example, either or both of the processor 14 and the display 16 are integrated within the handheld electronics device.

The handheld electronics device 12 is a transducer probe housing a transducer array, a cellular telephone, a personal digital data assistant, a music player, a camera, a digital camera, a remote control or other now known or later developed handheld electronics device. Devices having telephone or personal data assistant capabilities may only have these capabilities or may be combined with other electronics capabilities, such as a cellular phone having telephone and personal data assistant capabilities. Handheld electronics devices include devices sized or adapted to be held by an adult or child. Larger devices, such as laptops, are provided for mobility but without a handheld sizing. For example, FIGS. 2 and 3 show transducer probes 23 sized to be held in a user's hand for manipulation of a position of a transducer array 24 relative to a patient.

The handheld electronics device 12 of FIG. 1 includes active electronics 20, a sensor 18 and a housing 22. Additional, different or fewer components may be provided such as a display 16 integrated within the housing 22 with or without active electronics 20.

The active electronics 20 include transistors, analog devices, digital devices, application specific integrated circuits, processors, displays, or other now known or later developed electronics. For example, one or more circuit boards, semiconductor chips or processors are provided for transmitting and receiving radio or other signals. As another example, the active electronics 20 include a memory and associated software on a processor for providing time, calendar, contact or other information.

As yet another example shown by FIG. 2, the active electronics 20 include pre-amplifiers, multiplexers, switches, operational amplifiers, transistors, control circuits or other now known or later developed devices for operation within transducer probe 23. In one embodiment, the active electronics 20 include time division multiplexing circuits, subarray mixing circuits, partial beamforming circuits or other ultrasound specific processing devices. The transducer array 24 includes a linear or multi-dimensional array of transducer elements. For example, the transducer 24 shown in FIG. 2 is a two-dimensional or other multi-dimensional of piezo electric or capacitive based transducer elements. The active electronics 20 are operable to reduce a number of outputs from the large number of elements of the transducer array 24.

In yet another example shown in FIG. 3, a processor 16 as well as a wobbler drive 26 connected with a movable transducer array 24 are provided. Any now known or later developed wobbler probes may be used. For example, the drive 26 is a stepper or DC motor connected through gearing, other linkages or directly to a rotatable arm connected with the transducer array 24. In response to control signals from the processor 16, the drive 26 is operable to move the transducer array 24 back and forth past a center position shown in solid lines to acquire imaging planes at different positions within a volume. In the example of FIG. 3, the transducer array 24 is a linear array operable to acquire three-dimensional information by sweeping the linear array along different scan plane positions.

The housing 22 is rigid or flexible plastic, metal, glass, polymer, wood, synthetic material, resin or other now known or later developed materials for housing electronics. The housing 22 at least partially encloses the handheld electronics device 12. For example, the housing 22 entirely encloses the handheld electronics device 12 using plastic and glass, a single material or other combinations of materials. One or more ports, connectors, control buttons, knobs or other devices may be provided on the housing 22. In one embodiment, the housing 22 is adapted for being held in a hand, such as having a curved or other ergonomic shaping. The nature of the use or active electronics 20 may dictate the size and shape of the housing 22 as well, such as a CD player being shaped to house a compact disc or a cellular telephone being shaped to receive acoustic signals from a mouth and transmit acoustic signals to an ear.

In the embodiments shown in FIGS. 2 and 3, the housing 22 is a probe housing at least partially housing the transducer array 24. For example, the probe housing 22 includes a plastic or resin housing with a polymer, glass, plastic or other material for providing an acoustic window adjacent to the transducer array 24. Different portions of the housing 22 may be flexible, brittle or more susceptible to damage. The probe housing 22 also encloses any active electronics 20 (e.g. the processor 16 or other electronics).

The motion sensor 18 is operable to detect one of a shock and a drop of the handheld electronics device 12. The motion sensor 18 is in the housing 22. For example, the motion sensor is within a volume at least partially or entirely enclosed by the housing 22. In this embodiment, the motion sensor 18 is connected with an interior portion of the housing 22, integrated with other electronics positioned within the volume of space within the housing 22 or is a separate device positioned within the volume of space. As another example, the motion sensor 18 is integrated on the housing. For example, the motion sensor 18 is connected to an outside of the housing 22, formed as part of the housing 22 or positioned within a hole, divot or aperture of the housing 22. The word “on” is intended broadly to include the examples given above.

In one embodiment shown in FIG. 3, the motion sensor 18 is an accelerometer, such as small piezoresistive devices or prepackaged accelerometers in a single-, dual-axis, or triaxial-detecting device. Another example accelerometer is a MEMS-based device. The accelerometer is operable to detect a drop or a shock. For example, if the transducer probe 23 is dropped, the transducer probe 23 experiences substantially or near zero gravity in the brief interval prior to impact. Acceleration may be limited by air resistance or drag from a cable. A one meter fall from a stationary position spans nearly a half second at sea level, during which time the accelerometer detects the near zero gravity signal.

Any number of accelerometers may be used. For example, three miniature accelerometers are provided in any convenient space, but mounted in mutually perpendicular orientations. These components are interrogated by the ultrasound system or within the transducer probe in a dynamic mode, i.e., streaming acceleration data are processed continuously, and FIFO buffered for some fraction of a second. The timing and processing functions can be performed in software mounted in a standard ultrasound system.

In other embodiments, the motion sensor 18 is a shock sensor. Any of various now known or later developed shock sensors may be used, such as multi-sensors, accelerometers, multiple axis accelerometers, or dual axis accelerometers fabricated on with a submicron CMOS process (e.g., MEMs based device with or without an integrated circuit). In one embodiment, the shock sensor is a tape that is operable to change color in response to acceleration. Other passive sensors using no or little power may be used. Acceleration includes both increases as well as decreases in acceleration. For example, the deceleration associated with the handheld electronics device 12 contacting a table, floor or other structure causes a rapid deceleration. In response to a threshold amount of acceleration, the tape changes color. In other embodiments, the shock sensor is an accelerometer or other device for outputting information in response to a threshold amount of acceleration.

The shock sensors are operable to output an indication of previously experienced acceleration. For example, a tape outputs a color indication. As another example, output electrical signals or data are saved or otherwise electrically communicated to the processor 14. Any of various acceleration parameters may be provided by the shock sensor. Different shock sensors may provide different information.

The processor 14 is a general processor, a digital signal processor, an application specific integrated circuit, digital logic device, an analog processor or other now known or later developed processing device. In one embodiment, the processor 14 is connectable but remote from the handheld electronics device 12. For example, the processor 14 is operable to receive or query sensed motion data. Any of various acceleration parameters or other motion information is provided to the processor 14. In other embodiments, the processor 14 is part of or in the handheld electronics device 12. The processor 14 may communicate with other processors or generate a display on the handheld electronics device 12 or on a device separate from the handheld electronics device 12.

In one embodiment, the motion sensor 18 in conjunction with the processor 14 and an associated memory are operable to record the maximum acceleration, an acceleration history (acceleration as a function of time), the number of times acceleration exceeded a certain threshold value, other now known or later developed acceleration parameters or combinations thereof. The processor 14 or the associated memory is electronically interrogated or provides the acceleration parameter or parameters. Acceleration information may be used to determine whether the handheld electronics device 12 was subjected to dropping, hitting or other damage different than manufacturing defects. The information may be used to determine whether a warranty has been satisfied or to determine the need for additional protection or different design of the handheld electronics device 12.

In the embodiment shown in FIG. 3 or other embodiments, the motion sensor 18 in conjunction with the processor 16 detects a drop or other potential damage indicator during the event in order to prepare for and prevent damage. The processor 16 connects with the motion sensor and the drive 26. The processor 16 is the control processor for the drive 26 or a separate processor. The processor 16 is operable to control the wobbler drive 26 to position the transducer array 24 in response to detected drop information output from the accelerometer. For example, the processor 16 determines that the motion sensor 18 has indicated a near zero-gravity signal for a threshold amount of time, such as greater than 100 milliseconds. The threshold is set to provide time to position the transducer array 24 prior to impact. For example, the device may fall 5 centimeters in the first 100 milliseconds, 15 centimeters in a second 100 milliseconds, 24 centimeters in a third 100 milliseconds, and so on. At some point, the acceleration indicates a near zero-gravity signal. For example, the outputs of the three orthogonal accelerometers may each read close to zero g (say ±0.1 g) for a duration of at least 50 milliseconds.

The detection software overrides the scanning protocol and parks the transducer array 24. In response to a near zero-gravity signal or other acceleration associated with the likelihood of damage, the wobbler drive 26 positions the transducer array 24 in response to the detected drop or likely damage. For example, the transducer array 24 is moved from a center position shown in solid lines to a position associated with the endpoints of its sweep, such as shown by the dashed lines. In another embodiment, the transducer array 24 is designed with a dock at one or both ends of the array travel, which enclose and brace the array against impact. The transducer array 24 is kept docked when the wobbler is not scanning or docked in response to detected motion. If the array 24 is currently being used, the movement may be provided in a span of a hundred or a few hundreds of milliseconds. As a result, the transducer array 24 is less likely to be damaged if an exterior lens cap is dented or otherwise contacts a surface during a drop. The user may then manually reset the transducer before continuing, answering a prompt to inspect for damage before proceeding. Even if the lens cap is dented or otherwise renders the transducer array 24 inoperable, the amount of damage may be minimized. Lens caps are typically designed for easy replacement, allowing inexpensive refurbishment as long as the underlying transducer array 24, the drive 26 or other electronics are not damaged.

In one embodiment, a device, such as the transducer array 24 of a wobbler transducer, is provided with a bay, location or other region of increased or added protection. For example, an area associated with shock absorption or a more dense protective coating or housing is provided. In response to the detected drop, the component is positioned within the bay or region to further increase the protection.

In alternative embodiments, structures other than the transducer array 24 or other ultrasound probe related components are positioned for protection in response to a detected drop. In one embodiment, both positioning as well as recording a history of acceleration is provided. As a result, information for future designs to avoid damage is provided as well as an attempt at avoiding the damage in response to a current shock.

The display 16 is an LED, LCD, CRT, projector, dial, mechanical device, electrical device, visual indication (e.g. color of a substance), chemical device or other now known or later developed displays. For example, the display 16 is the color of the color-changing shock sensor tape. As another example, the display 16 is a CRT or LCD monitor associated with the processor 14 separate from the handheld electronics device 12. As yet another example, the display 16 is an LCD, LED or other display provided on the handheld electronics device 12 for use as an indicator of the shock sensor or for a display having multiple uses. In one embodiment, the display outputs an indication of previous acceleration or shock, such as a bar graph, a date of maximum shock, an amplitude of maximum shock or other information. The output is provided in response to input by a user or a secure input by a manufacturer or other restricted source. Alternatively, the display outputs previously recorded information on an ongoing or continuous basis.

In one embodiment, the display is activated by detection of the shock by the shock sensor. For example, a color change of the color-changing shock sensor is activated. As another example, a warning light is activated in response to a sensed shock. A warning light, audio or visual display may be provided to indicate that a handheld electronics device 12 should be serviced due to excessive shock.

In the embodiments shown in FIGS. 2 and 3, the motion sensor 18 is positioned in the transducer probe 23. The transducer cable of the transducer probe 23 may connect with a connector housing that also includes electronics. For example, U.S. Pat. Nos. ______ and ______ (U.S. application Ser. Nos. ______ and ______ (attorney reference numbers 2003P14534US and 2003P14535US)), the disclosures of which are incorporated herein by reference, disclose electronics in a connector housing. The connector housing is part of a transducer probe assembly with the cable and transducer probe. The connector housing releasably attaches to an ultrasound imaging system. Since the active electronics of the connector housing may also be subjected to undesired shocks, a separate motion sensor is positioned in the connector housing. The connector housing is a handheld electronics device used for connecting and disconnecting the transducer probe assembly to the imaging system. Other now known or later developed handheld electronics devices may be provided, including devices with limited handheld use.

FIG. 4 shows a flowchart of one embodiment of a method for detecting damage risk in a handheld electronics device. Additional, different or fewer acts may be provided in other embodiments. The method is performed using the handheld electronics device of FIG. 1, FIG. 2, FIG. 3 or other now known or later developed handheld electronics devices.

In act 42, a shock is detected from within a handheld electronics device. The shock is from any source of contact or acceleration without contact. For example, the user shakes the handheld device, resulting in a shock from rapid acceleration. The shock is detected with a motion sensor within or on a housing of the handheld electronics device. Any of various levels of shocks may be detected, including detecting different levels of shock.

In act 44, the detected shock is indicated. For example, a display generates an indication of a shock. Using electrical, chemical or mechanical activation, the shock is indicated. The shock is indicated at the time of occurrence, shortly after the time of occurrence, or at a much later time. For example, the shock is indicated in response to formation of a communications link, an inquiry or other triggering event. In one embodiment, the shock is indicated by outputting data corresponding to previously experienced acceleration.

FIG. 5 shows a flowchart of one embodiment of a method for preventing damage in a handheld electronics device. Additional, different or fewer acts may be provided. The method is implemented using the handheld electronics devices of FIG. 1, FIG. 2, FIG. 3 or other now known or later developed handheld electronics devices.

In act 46, a drop is detected from within a handheld electronics device. For example, acceleration associated with gravity is detected. A near zero-gravity or other acceleration indicates a drop. In one embodiment, the drop is detected by matching an acceleration curve to an acceleration likely associated with a drop, taking into account any of various factors such as the connection of a cable. In alternative embodiments, an acceleration threshold, other acceleration profiles or other characteristics are used to detect a drop. The sensed data may be filtered or hysteresis used to determine whether a drop has occurred.

In one embodiment, the drop is detected from within an ultrasound wobbler transducer. Before, during or after use to scan a patient, a wobbler transducer may be dropped. For example, a sonographer accidentally releases the wobbler transducer. As the transducer falls, a drop is detected. Rapid acceleration is detected. Alternatively, acceleration associated with near zero-gravity over a hundred milliseconds or other time period is detected. The transducer cable may act to limit acceleration to slow the acceleration due to gravity. The detection of the drop accounts for likely drag caused by the transducer cable.

In act 48, a component is positioned in response to the detected drop. The component is moved to a protective region in one embodiment. In other embodiments, the component is moved to a region less likely to result in damage due to shock. In the transducer wobbler array example above, the transducer array is moved away from a center position, such as to a position as far away from a lens or along the lens but closer to a sturdier portion of the housing. The positioning is performed by braking the movement of the transducer array or by actively controlling movement of the array to the desired position. As another example, a portion of a lock mechanism is positioned in response to the detected drop. The lock mechanism keeps fragile components from flexing or moving due to a shock. As a further example, a protective shield is deployed adjacent to and just inside the lens cap, after the array has been repositioned to a safe location, in order to support the lens cap from inside and prevent denting on impact. Positioning of the component is performed in response to the detected drop, such as immediately after detected drop, to more likely protect the component before a shock occurs. Delayed responses are provided in other embodiments.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. An ultrasound transducer probe for detecting damage risk or preventing damage, the ultrasound transducer probe comprising:
a transducer array;
a probe housing at least partially housing the transducer array; and
a motion sensor operable to detect one of a shock and a drop of the probe housing.

2. The ultrasound transducer probe of claim 1 further comprising:
active electronics housed by the probe housing.

3. The ultrasound transducer probe of claim 1 wherein the motion sensor is within a volume at least partially enclosed by the housing.

4. The ultrasound transducer probe of claim 1 wherein the motion sensor is integrated on the housing.

5. The ultrasound transducer probe of claim 1 further comprising:
a wobbler drive connected with the transducer array;
wherein the motion sensor comprises an accelerometer.

6. The ultrasound transducer probe of claim 5 wherein the accelerometer is operable to detect the drop, the wobbler drive operable to position the transducer array in response to the detected drop.

7. The ultrasound transducer probe of claim 6 wherein the wobbler drive is operable to position the transducer array away from a center position in response to the detected drop.

8. The ultrasound transducer probe of claim 6 further comprising:
a processor connected with the accelerometer, the processor operable to detect a drop in response to an about zero-gravity signal output from the accelerometer for a period of time.

9. The ultrasound transducer probe of claim 1 wherein the motion sensor comprises a shock sensor.

10. The ultrasound transducer probe of claim 9 wherein the shock sensor comprises a tape operable to change color in response to acceleration.

11. The ultrasound transducer probe of claim 9 wherein the shock sensor is operable to electrically communicate an acceleration parameter with a processor.

12. The ultrasound transducer probe of claim 9 wherein the shock sensor is operable to output an indication of previously experienced acceleration.

13. The ultrasound transducer probe of claim 9 further comprising:
a display activated by detection of the shock by the shock sensor.

14. A system for detecting damage risk or preventing damage in a handheld electronics device, the system comprising:
a housing at least partially enclosing the handheld electronics device; and
a motion sensor operable to detect one of a shock and a drop of the handheld electronics device, the motion sensor one of in and within the housing.

15. The system of claim 14 wherein the motion sensor is within a volume at least partially enclosed by the housing.

16. The system of claim 14 wherein the motion sensor is integrated on the housing.

17. The system of claim 14 wherein the motion sensor comprises an accelerometer.

18. The system of claim 17 wherein the handheld electronics device comprises a wobbler probe having a transducer array and a drive operable to move the transducer array;
further comprising:
a processor connected with the accelerometer and the drive, the processor operable to control the wobbler drive to position the transducer array in response to drop information output from the accelerometer.

19. The system of claim 14 wherein the motion sensor comprises a shock sensor.

20. The system of claim 19 wherein the shock sensor is operable to output an indication of previously experienced acceleration.

21. The system of claim 14 wherein the handheld electronics device comprises an ultrasound transducer probe.

22. The system of claim 14 wherein the handheld electronics device comprises a device having cellular telephone capabilities.

23. The system of claim 14 wherein the handheld electronics device comprises a device having personal data assistant capabilities.

24. A method for detecting damage risk in a handheld electronics device, the method comprising:
(a) detecting shock from one of in and within the handheld electronics device; and
(b) indicating the detected shock.

25. The method of claim 24 wherein (b) comprises changing a color.

26. The method of claim 24 wherein (b) comprises outputting data corresponding to previously experienced acceleration.

27. The method of claim 24 wherein (a) comprises detecting the shock with a motion sensor within a housing of the handheld electronics device.

28. The method of claim 24 wherein (a) comprises detecting the shock from within one of: an ultrasound transducer probe, a personal data assistant, a cellular telephone and a music player.

29. A method for preventing damage in a handheld electronics device, the method comprising:
(a) detecting a drop from one of on and within the handheld electronics device; and
(b) positioning a component in response to the detected drop.

30. The method of claim 29 wherein (a) comprises detecting acceleration associated with gravity.

31. The method of claim 30 wherein (a) comprises detecting a near zero-gravity.

32. The method of claim 29 wherein (b) comprises moving a component to a protective region.

33. The method of claim 29 wherein (a) comprises detecting the drop from within an ultrasound wobbler transducer, and wherein (b) comprises positioning a transducer array away from a center position.

34. The method of claim 29 wherein (a) comprises detecting the drop from within an ultrasound wobbler transducer, and wherein (b) comprises positioning a protective shield adjacent to the lens cap.
